(19) United States
(12) Patent Application Publication
(10) Pub. No.: US 2019/0001552 A1
(43) Pub. Date: Jan. 3, 2019

(54) 3D PRINTER AND PRINTING SYSTEM

(71) Applicants: Seong Jin PARK, Seogwipo-si, Jeju-do (KR); Hong Joo LEE, Seoul (KR); Hwan Ook JU, Yongin-si ,Gyeonggi-do (KR); RYUJIN LAB , INC., Seongnam-si ,Gyeonggi-do (KR)

(72) Inventors: Seong Jin PARK, Seogwipo-si (KR); Hong Joo LEE, Seoul (KR); Hwan Ook JU, Yongin-si (KR)

(21) Appl. No.: 15/748,595

(22) PCT Filed: Jul. 28, 2016
(86) PCT No.: PCT/KR2016/008310

§ 371 Date: Jan. 29, 2018

(30) Foreign Application Priority Data
Jul. 28, 2015 (KR) 10-2015-0106490
Jul. 28, 2016 (KR) 10-2016-0096228

(51) Int. Cl. B29C 64/135; B29C 64/205; B33Y 10/00; B29C 64/386

(52) U.S. Cl. CPC B29C 64/135; B29C 64/205; B33Y 30/00; B29C 64/386; B33Y 10/00

(57) ABSTRACT

The present invention relates to a 3D printer and a printing system. The present invention may include: a storage unit formed in a hexahedral shape and having an open top and a bottom surface formed of a film layer comprising an upper film layer, the storage unit storing a photocurable material therein; a light source unit comprising at least one light emitting diode, the light source unit being disposed below the storage unit and radiating light toward the photocurable material; and a switching unit comprising an LCD panel disposed between the light source unit and the storage unit, the switching unit opening and closing each pixel included in the LCD panel to selectively pass light emitted from the light source unit toward the photocurable material. Accordingly, light emitted from below the storage unit can be emitted toward the photocurable material without being distorted.

### TECHNICAL FIELD

The present invention relates to a three-dimensional printer and a printing system, and more particularly, to a three-dimensional printer and a printing system including a storage unit formed of a film layer.

### BACKGROUND ART

3D printer technology is a technology that can fabricate a complicated structure in a short time by stacking layers of outputs corresponding to the drawings created using Computer Aided Design (CAD) without cutting work. Recently, this technology has been actively used in industries such as medicine, the automobile industry, the shipping industry, and the footwear industry beyond prototype manufacturing.

Typical 3D printer technologies include stereo lithography apparatus(SLA), which uses a photo curable material to cure the material by radiating light or laser to fabricate a structure, and Selective Laser Sintering (SLS), which uses plastics or metal powder to fabricate a structure by sintering the material by radiating laser.

As 3D printer technology has developed, technology for enhancing accuracy of the output has become increasingly important. In this regard, Korean Patent No. 10-1533374 discloses a 3D printer having a projector installed under a storage of a photo curable material to concentrate light emitted from the projector in the storage and produce high precision output.

However, when a projector is provided as a constituent of the 3D printer, a large projector is included as a constituent of the 3D printer in order to print large output objects, and accordingly the size of the 3D printer is inevitably increased, resulting in cost increase.

Therefore, there is a need for technology to address the aforementioned issue.

It should be noted that the statements in this section are technical information possessed by the inventor for derivation of the present invention or acquired in the process of derivation of the present invention, and cannot necessarily be a known technology disclosed to the public before application of the present invention.

### DISCLOSURE

### Technical Problem

It is one object of the present invention to provide a 3D printer and a printing system.

### Technical Solution

In accordance with one aspect of the present invention, provided is a three-dimensional (3D) printer including: a storage unit formed in a hexahedral shape and having an open top and a bottom surface formed of a film layer comprising an upper film layer, the storage unit storing a photo curable material therein; a light source unit comprising at least one light emitting diode, the light source unit being disposed below the storage unit and radiating light toward the photo curable material; and a switching unit comprising an LCD panel disposed between the light source unit and the storage unit, the switching unit opening and closing each pixel included in the LCD panel to selectively pass light emitted from the light source unit toward the photo curable material.

### Advantageous Effects

According to one embodiment of the present invention, in a 3D printer, a storage unit for storing a photocurable material is formed of a low-elasticity film, and accordingly the photocurable material may be irradiated with light emitted from below the storage unit without being distorted. According to one embodiment of the present invention, since the storage unit of the 3D printer included in the present invention is formed of a film layer composed of a low-elasticity film and a high-elasticity film, the output may be easily separated from the storage unit, and durability of the storage unit may be improved compared to a storage unit made of other materials.

According to one embodiment of the present invention, since the 3D printer included in the present invention includes a support portion for supporting the switching unit, the switching unit may not be displaced from the position thereof or the switching unit may be prevented from sagging even if the switching unit contacts a platform.

### DESCRIPTION OF DRAWINGS

FIG. 1 is a configuration diagram illustrating respective elements included in a printing system according to an embodiment of the present invention.

FIG. 2 is a configuration diagram illustrating a film layer included in the 3D printer according to an embodiment of the present invention.

FIG. 3 is a configuration diagram illustrating configuration of a light source unit and a light condensing unit included in a 3D printer according to an embodiment of the present invention.

FIG. 4 is an exemplary view showing an analysis model with which a 3D printer according to an embodiment of the present invention analyzes a cross-sectional image of a cross section of a three-dimensional drawing.

### BEST MODE

Hereinafter, embodiments of the present invention will be described in detail with reference to the accompanying drawings so that those skilled in the art can easily carry out the present invention. The present invention may, however, be embodied in many different forms and should not be construed as limited to the embodiments set forth herein. In order to clearly illustrate the present invention, parts not related to the description are omitted, and like parts are denoted by like reference numerals throughout the specification.

Throughout the specification, it should be understood that, when a part is stated as being “connected” to another part, it may be directly connected or indirectly connected to the other part. Further, it should also be understood that, when a part is stated as “including” an element, this does not exclude other elements, but means that the part may further include other elements, unless specifically stated otherwise.

Prior to describing the present invention, terms employed herein will be described.

In the drawings, like reference numerals refer to like elements throughout. It is to be understood that elements of other drawings may be cited when necessary in the description of the drawings.

In the present invention, the “photocurable” material is a material that is cured from a liquid state to a solid state when irradiated with light. For example, the resin may be a photocurable material.

In the present invention, a “pixel” is the smallest unit of a specific element. In an embodiment of the present embodiment, the pixel is the smallest unit that is closed when there is an input signal in a two-dimensional plane of a switching unit 130 and is opened when there is no input signal.

In the present invention, a “3D drawing” d1 refers to data obtained by three-dimensionally modeling a final output using a CAD program or the like. Here, the “final output” is an object the user desires to build, and the “output” is an object printed by the 3D printer, using a “2D drawing” d2 formed by processing the “3D drawing” d1.

In the present invention, the “platform” is formed in the shape of a vertically moveable plate, and the lower portion thereof is provided with an element and device that complete a final output in the 3D printer by sequentially attaching sequentially completed outputs.

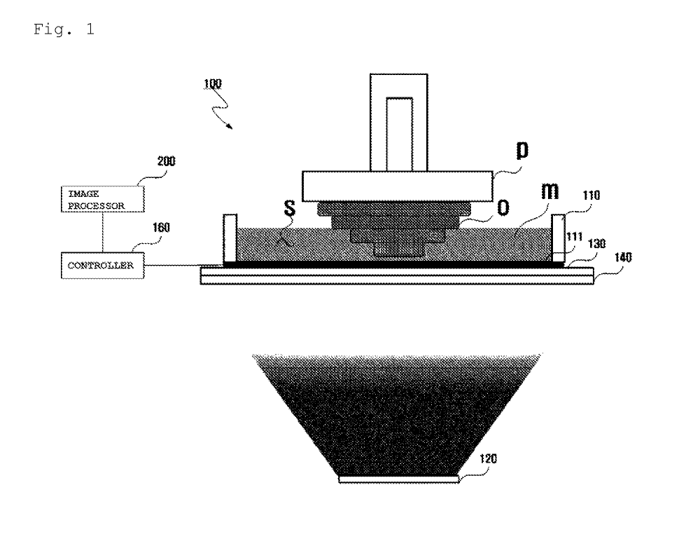

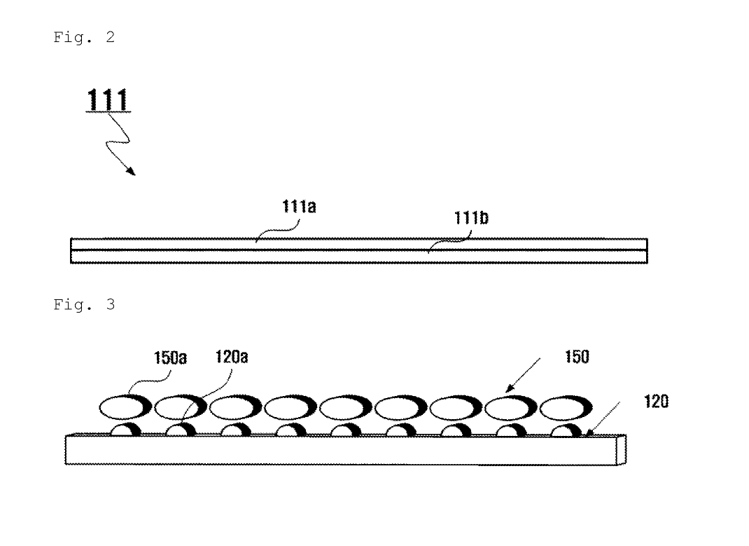

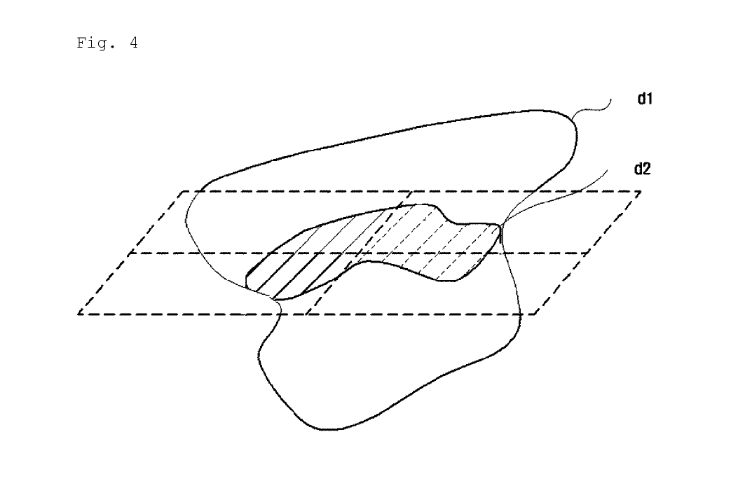

Hereinafter, each of the elements included in the 3D printer 100 will be described with reference to FIGS. 1 to 4. FIG. 1 is a configuration diagram illustrating respective elements included in a printing system according to an embodiment of the present invention, and FIG. 2 is a configuration diagram illustrating a film layer included in the 3D printer 100 according to an embodiment of the present invention. FIG. 3 is a configuration diagram illustrating configuration of a light source unit and a light condensing unit included in the 3D printer 100 according to an embodiment of the present invention, and FIG. 4 is an exemplary view showing an analysis model with which the 3D printer 100 according to an embodiment of the present invention analyzes a cross-sectional image d2 of a cross section of a three-dimensional drawing d1.

The 3D printer 100 according to an embodiment of the present invention is an element and device that store a photocurable material m therein, irradiate a specific position of the stored photocurable material m with light to generate an output, and finally construct a final output by stacking the outputs.

First, the 3D printer according to an embodiment of the present invention may include a storage unit 110 for storing the photocurable material m therein.

The storage unit 110, which is an element and device for storing the photocurable material m therein, may be formed in a hexahedral shape having an open top and a storage space s formed therein.

Specifically, as shown in FIG. 1, the photocurable material m stored in the storage unit 110 is cured when irradiated with the light. The platform p enters the storage space s through the open top, and then rises after adhering to an output m which is the cured photocurable material m.

A film layer 111 may be formed on the bottom surface of the storage unit 110. The film layer 111, which is an element for supporting the stored photocurable material m placed thereon, may be formed of a material that does not sag even if the photocurable material m is contained thereon.

When the platform p adheres to the output o and raises the position of the output o, the film layer 111 may be easily separated from the output o and maintain an appropriate strength. To this end, the film layer 111 may include an upper film layer 111a and a lower film layer 111b as shown in FIG. 2. The upper film layer 111a and the lower film layer 111b may be attached to each other so as to not be separated from each other.

The upper film layer 111a may be formed of a film material which is easily bent even by a small force, and the upper surface thereof may be brought into direct contact with the photocurable material m and the output o, which is formed by curing the photocurable material.

Specifically, the photo polymerizable material m on the top surface of the upper film layer 111a may be cured to generate the output o. As described above, when the platform p disposed over the storage unit adheres to the output o on the upper surface of the photocurable material m and then rises together with the output o, the output o and the film layer 111 rise together since the output o adheres not only to the platform p but also to the film layer 111. At this time, since the upper film layer 111a is better in malleability and ductility, parts relatively weakly adhering to the output o will be separated from the output by gravity and sag, and consequently the entire upper film layer 111a will be separated from the output.

The upper film layer 111a may be formed of a thin film material having good light transmittance, for example, a fluororesin film, which may include a PFA (Perfluoroalkoxy) film, a Teflon film, an ETFE (Ethylene Tetra Fluoro Ethylene) film, and a PCTFE (Polychlorotrifluoroethylene) film.

However, if only the upper film layer 111a is included in the film layer 111, the upper film layer 111a may be easily bent and broken due to high malleability and ductility. Thus, the film layer 111 includes a lower film layer 111b to maintain the shape of the upper film layer 111a by limiting the malleability and ductility of the upper film layer 111a to an extent that the upper film layer 111a is not broken.

Specifically, the lower film layer 111b is made of a material which is less malleable and less ductile than the upper film layer 111a, and is located under the upper film layer 111a. The upper surface of the lower film layer 111b may be in close contact with the upper film layer 111a and the lower surface of the lower film layer 111b may be in close contact with the upper surface of the switching unit 130.

The lower film layer 111b may be configured with a film having lower malleability and ductility than the upper film layer 111a and having good light transmittance. For example, the lower film layer 111b may include a PET (polyethylene terephthalate) film.

The 3D printer 100, which is an embodiment of the present invention, may include a light source unit 120. The light source unit 120 is a device that radiates light toward the storage unit 110.

The light source unit 120 may include at least one light emitting diode (LED) disposed below the storage unit 110. The light source unit 120 may emit ultraviolet light to cure the photocurable material.

Specifically, as shown in FIG. 1, the light source unit 120 is disposed below the storage unit 110. As shown in FIG. 3, a plurality of LEDs 120a may be included in the upper surface of the light source unit 120. The number of the LEDs 120a may correspond to pixels arranged in the switching unit 130, which will be described later, and may be arranged at positions corresponding to the pixels, respectively. Each of the LEDs may radiate light toward a corresponding one of the pixels.

The 3D printer 100, which is an embodiment of the present invention, may include a switching unit 130.

The switching unit 130 may allow the light radiated from the light source unit 120 to be transmitted therethrough toward the film layer 110 so as to correspond to a cross-sectional image d2 supplied from a controller 200, which will be described later.

Specifically, the switching unit 130 may include an LCD panel. The LCD panel may include pixels, each of which selectively allows light to be transmitted therethrough, and may be formed in a TN (Twisted Nematic) structure, an IPS (In-Plane Switching) structure or a VA (vertical alignment) structure in order to prevent glare.

Here, the TN structure refers to a structure that allows light to be transmitted therethrough due to unidirectional orientation of the liquid crystal molecules in the LCD panel when a voltage is applied to the liquid crystal molecules and does not allow light to be transmitted therethrough due to orientation of the liquid crystals in different directions when the voltage is not applied.

The respectively pixels arranged in the switching unit 130 may be opened or shielded in a shape corresponding to the cross-sectional image d2 under control of the controller 200, which will be described later.

In addition, since the switching unit 130 should transmit the light emitted from the light source unit 120 toward the photocurable material m while absorbing as little light as possible, it may be formed of a material capable of withstanding ultraviolet wavelengths near 400 nm.

The 3D printer 100, which is an embodiment of the present invention, may include a support portion 140.

The support 140 may be formed of a material that has good light transmittance and is capable of supporting a predetermined weight. For example, the support portion 140 may be formed of DIAMANT glass which has light transmittance higher than or equal to 98% and a thickness greater than or equal to 1 T. Hereinafter, the support portion 140 will be described on the assumption that the support portion 140 is formed of DIAMANT glass.

The supporting part 140 may be formed in the shape of a rectangular plate. The support portion 140 is disposed under the switching part 130. When the output o adheres to the platform P, the platform p presses the switching part 130 due to weight thereof. In this case, lowering or sagging of the switching unit 130 may occur. To prevent the support portion 140 from being lowered or sagging, the support portion 140 in the shape of a rectangular plate may be arranged under the switching unit 130 to support the switching unit 130.

The 3D printer 100, which is an embodiment of the present invention, may include a light condensing unit 150.

The light condensing unit 150 may be disposed over the light source unit 120 and include at least one condensing lens 150a corresponding to the respective LEDs 120a included in the light source unit 120.

Specifically, the LEDs 120a radiate light in all directions. Each of the condensing lenses 150a condenses light transmitted through each LED 120a toward a pixel corresponding to each of the LEDs 120a. Here, the condensing lenses 150a may be formed in the shape of a convex lens since they need to condense the light emitted from the LEDs 120a.

The 3D printer 100 according to an embodiment of the present invention may include a controller 160.

The controller 160 may open and close each pixel included in the switching unit 130 based on the cross-sectional image o received from an image processor 200, which will be described later.

Specifically, the controller 160 may sequentially receive cross-sectional image d2 from the image processor 200. The controller 160 may open pixels corresponding to the cross-sectional image d2 to allow light be transmitted through the pixels, and close the pixels that do not correspond to the cross-sectional image d2 in order to prevent light from being transmitted through the pixels.

As described above, the switching unit 130 may be constituted by an LCD panel. When a current flows through each pixel included in the LCD panel, external light is not allowed to be transmitted through the pixels. When current does not flow, the pixels allow the light to be easily transmitted therethrough. Therefore, no current flows through the pixels corresponding to the cross-sectional image d2, and a current flows through the pixels that do not correspond to the cross-sectional image d2.

Hereinafter, a printing system employing the 3D printer 100 described above will be described. The printing system is a system configured to extract the cross-sectional image d2 based on the 3D drawing d1 and print a final output using the extracted cross-sectional image d2.

The printing system, which is an embodiment of the present invention, may include the 3D printer 100 and the image processor 200 described above.

When the 3D drawing d1 is input from the outside, the image processor 200 analyzes the 3D drawing d1 to generate horizontal cross-sectional images for predetermined heights, and sequentially supplies the horizontal cross-sectional images to the controller 160.

Specifically, as shown in FIG. 4, in order for the 3D printer 100 to produce a final output, the image processor 200 may analyze the 3D drawing d1 of the final output at predetermined heights to create a plurality of horizontal cross-sectional images d2. For example, the predetermined heights may be set by the user, or may be heights corresponding to the sizes of the respective pixels arranged in the switching unit 130.

The controller 160 may open and close the pixels of the switching unit 130 based on the received horizontal cross-sectional images d2. The controller 160 controls the switching unit 130 in the same manner as in the case of the switching unit 130 included in the 3D printer 100, and thus description thereof is omitted.

Regarding the position of the image processor 200, while FIG. 1 illustrates that the image processor 200 is disposed outside the 3D printer 100, the image processor 200 may be arranged inside the 3D printer 100.

It will be understood by those of ordinary skill in the art that various changes in form and detail can be made to the present invention without departing from the spirit and scope of the present invention. It is therefore to be understood that the above-described embodiments are illustrative in all aspects and not restrictive. For example, each component described as a single entity may be implemented in a distributed manner. Similarly, components described as being distributed may be implemented in a combined form.

The scope of the present invention is defined by the appended claims rather than the detailed description, and all changes or modifications derived from the meaning and scope of the claims and their equivalents are to be construed as being within the scope of the present invention.

1. A three-dimensional (3D) printer comprising:
a storage unit having atop surface formed in an open hexahedral shape and a bottom surface formed of a film layer comprising an upper film layer, for storing a photocurable material therein;
a light source unit comprising at least one light emitting diode, the light source unit being disposed below the storage unit and radiating light toward the photocurable material; and
a switching unit comprising an LCD panel disposed between the light source unit and the storage unit, the switching unit opening and closing each pixel included in the LCD panel to selectively pass light emitted from the light source unit toward the photocurable material.

2. The 3D printer according to claim 1,
wherein the film layer further comprises lower film layer disposed under the upper film layer to closely contact an upper surface of the switching unit, the upper film layer directly contacts the photocurable material.

3. The 3D printer according to claim 1,
wherein the upper film layer has higher malleability and ductility than the lower film layer.

4. The 3D printer according to claim 3,
wherein the upper film layer consists of a fluororesin film.

5. The 3D printer according to claim 3,
wherein the lower film layer consists of a PET film.

6. The 3D printer according to claim 1, further comprising a support portion disposed under the switching unit to support the switching unit such that a position and shape of the switching unit are fixed.

7. The 3D printer according to claim 1, comprising a condensing unit disposed over the light source unit, the condensing unit comprising at least one condensing lens corresponding to each of the light emitting diode included in the light source unit, he condensing lens condensing light emitted from the light source unit at preset coordinates.

8. A printing system including the 3D printer according to any one of claims 1 to 7,
the printing system comprising an image processor configured to analyze a three-dimensional drawing to generate horizontal cross-sectional images according to predetermined heights, and to consecutively transmit each of the horizontal cross-sectional images to the switching unit,
the 3D printer comprising a controller configured to open each pixel corresponding to each of the horizontal cross-sectional images.
